(19) United States
(12) Patent Application Publication
(10) Pub. No.: US 2015/0128096 A1
(43) Pub. Date: May 7, 2015

(54) SYSTEM TO FACILITATE AND STREAMLINE COMMUNICATION AND INFORMATION-FLOW IN HEALTH-CARE

(71) Applicant: Sidra Medical and Research Center, Doha (QA)

(72) Inventors: Avez Ali RIZVI, Knoxville, TN (US); Saif Reza AHMED, Brooklyn, NY (US); Deepak KAURA, Doha (QA)

(21) Appl. No.: 14/531,394

(22) Filed: Nov. 3, 2014

Related U.S. Application Data
(60) Provisional application No. 61/899,851, filed on Nov. 4, 2013.

(51) Int. Cl. G06F 3/01; G02B 27/01

(52) U.S. Cl. CPC G06F 3/017; G02B 27/017; G02B 2027/0178
USPC 715/863

(57) ABSTRACT

Processes and systems for facilitating communications in a health care environment are provided. In one example, a process includes receiving a trigger from a wearable computer device to communicate with a medical application interface. The trigger may include detecting a hand gesture of a user of a wearable computer device (e.g., via a camera device or motion sensing device associated with the wearable computer device). The process may then display information associated with the medical application interface on the wearable computer device, and receive input from a user via the wearable computer device for interacting with the medical application interface. Displayed information may include patient information, medical records, test results, and so on. Further, a user may initiate and communicate with a remote user, the communication synchronizing information between two or more users (e.g., to synchronously view medical records, medical image files, and so on)

### CROSS-REFERENCE TO RELATED APPLICATION

This application claims the benefit of priority to U.S. Provisional Ser. No. 61/899,851, filed on Nov. 4, 2013, entitled SYSTEM TO FACILITATE AND STREAMLINE COMMUNICATION AND INFORMATION-FLOW IN HEALTH-CARE, which is hereby incorporated by reference in its entirety for all purposes.

### FIELD

This relates generally to the field of medicine, including consultation and communication within medicine using telecommunication and mobile computing devices, and, in one example, to augmented reality devices and wearable computing devices such as head mounted wearable computer devices and gesture-driven input devices.

### BACKGROUND

Consultation between various health care professionals is critical in a medical care setting, whether in a hospital or an out-patient setting. While consultation has several major metrics associated with it, medical errors resulting from a lack of inter-physician consultation or late consultation are costly for both monetary cost and patient care.

In particular, medical errors account for billions in lost health care dollars. A significant percentage of errors are due to ineffective communication between health care professionals. Several previous methods of digital verification and communication have been proposed and implemented to help increase consultation and communication between health care professionals. For example, “urgent finding” systems have been implemented in various hospitals that indirectly contact physicians in care of patients if a finding is in need of urgent attention. These systems usually utilize digital systems such as the electronic medical record or department specific systems, e.g., radiology information systems or emergency medicine information systems. While these devices and processes have made some impact, the problem is still pervasive.

Certain devices such as augmented reality wearable devices (e.g., Optical Head-Mounted Display (OHMD) such as Google Glass or the like) exist today that can facilitate real-time consultation. In addition, certain gesture driven motion detection equipment such as the MYO™ armband or LeapMotion sensor unit exist today that allow for digital control of devices via alternative input mechanisms.

Medicine is a unique field where standard input mechanisms (e.g., keyboards, touch screens, mice, and the like) have not been integrated successfully for efficient communication because they disrupt the sterile field, forcing doctors to scrub out and back in, often under time-sensitive conditions.

What is needed in the field are new computer implemented methods and systems that would allow for new devices (e.g., wearable devices) to be used specifically in the health care setting (e.g., hospital, urgent care, or out-patient setting) in order to allow for real-time or streamlined consultation between health care professionals as well as to serve as mediums for better control of processes during invasive procedures such as surgery.

### BRIEF SUMMARY

According to one aspect of the present invention, a system and computer-implemented method for facilitating communications in a health care environment are described. In one example, a process includes receiving a trigger from a wearable computer device to communicate with a medical application interface. The trigger may include detecting a hand gesture of a user of a wearable computer device (e.g., via a camera device or motion sensing device associated with the wearable computer device. The process may then display information associated with the medical application interface on the wearable computer device, and receive input from a user via the wearable computer device for interacting with the medical application interface. Displayed information may include patient information, medical records, test results, and so on.

In some examples, a user (e.g., a physician) may initiate and communicate with a remote user (e.g., another physician or professional). The communication may include conventional communication methods but also include synchronizing displays between two or more users (e.g., to synchronously view medical records, medical image files, and so on).

In yet further examples, a user (e.g., a physician) may initiate and control medical devices or equipment. For example, a user may input controls to move or activate medical devices, and may also receive and view images captures by medical devices such as cameras associated with laparoscopic, endoscopic, or fluoroscopic devices.

Additionally, systems, electronic devices, graphical user interfaces, and non-transitory computer readable storage medium (the storage medium including programs and instructions for carrying out one or more processes described) for facilitating communication and information-flow in health care settings and providing various user interfaces are described.

### BRIEF DESCRIPTION OF THE DRAWINGS

The present application can be best understood by reference to the following description taken in conjunction with the accompanying drawing figures, in which like parts may be referred to by like numerals.

FIG. 1 illustrates an exemplary process flow associated with a patient visiting an emergency room, illustrating an emergency room physician interfacing with a radiologist and a clinical support decision system.

FIG. 2 illustrates an exemplary process for initiating a medical interface or task flow (which may include viewing medical records, receiving information, controlling medical equipment, or the like).

FIG. 3 illustrates an exemplary process for initiating communication between two users (e.g., between two medical professionals), wherein at least one of the users is communicating via a wearable computer device.

FIG. 4 illustrates an exemplary system and environment in which various embodiments of the invention may operate.

FIG. 5 illustrates an exemplary computing system.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

This disclosure relates generally to computer-implemented systems and processes for use with augmented reality head-mounted displays, gesture driven motion detection equipment (e.g., with camera or motion sensing devices), and voice control input mechanisms on mobile devices in order to allow for communication in real-time between health care professionals. In some examples, gesture driven hand-movements can be detected by an external gesture driven device in addition to the head mounted computer display. For example, a watch or arm/hand device, configured to detect gestures. The use of these devices can also be used in a procedure setting, for example, in an operating room. Certain health care professionals can use head mounted computer displays and gesture driven motion detection equipment during their routine examination of patients and during surgical and interventional procedures, as well as to annotate images or record files displayed on a head mounted display.

This disclosure further relates to exemplary processes for allowing users (e.g., clinicians using the aforementioned devices) to use the devices in order to send and receive patient information in real-time or asynchronously. This includes information received from other health care professionals (e.g., other doctors, nurses, and the like) in the form of consultation or communication of information related to patient care to the end user of the devices or vice versa.

Some embodiments further relate to the manipulation of medical images, operating room surgical equipment, and medical equipment in general by the head mounted computer display and gesture driven motion detection equipment worn by the end users. In one example, medical images (e.g., Digital Imaging and Communications in Medicine (DICOM) files or otherwise) may be streamed in real-time to and from a head-mounted computer device and the software application interface described herein. Further, a process of manipulating medical images on the head-mounted computer device using gesture driven hand-movements via an external gesture control device is provided. The medical images may include tomography scan images, magnetic resonance imaging scan images, ultrasound scan images, X-ray images, fluoroscopic images, nuclear medicine scan images, pathology information system images, pathology histology slide images, pathology frozen section images, pathology gross specimen images, pathology related images, real-time physical exam findings on a patient, real-time surgical images, real-time post-traumatic findings, real-time patient findings, or any other images directly sent between health care professionals as they relate to communication and consultation in patient care.

Additionally, in some examples, voice recognition may be used to manipulate information, for example, to manipulate or annotate real-time feed data from medical laparoscopic, endoscopic, fluoroscopic cameras and image detectors such as pausing, stopping, rewinding, fast-forwarding, and recording the data feed.

In one aspect, the exemplary processes can be implemented as software solutions to interface with a variety of hardware interfaces in order to allow for the aforementioned hardware device processes to occur effectively.

For example, a user can view vital signs, either real-time or historical or last-read, on augmented reality devices, either retrieved from a central repository or directly via connected devices (e.g., Bluetooth devices). In some examples, the wearable computer device can operate to launch and display a patient dashboard, display of vital signs for a particular patient and/or medical device, or more generally, an entity, based on an entry-point mechanism (described below). The dashboards can be populated with information from real-time sources and central repositories for a variety of electronic medical record (EMR) and electronic health record (EHR) types, including but not limited to medical history, physical examination information, allergies, lab result(s), lab result(s) status, and so on.

Further, the systems and process may display real-time data feeds from surgical laparoscopic and endoscopic cameras during a procedure or surgery to a head-mounted computer display. In other examples, displaying real-time feed date from fluoroscopic imaging procedures in interventional procedures such as interventional radiology, cardiology, nephrology, neurosurgery, and urology to the head mounted device.

Further, a user may control medical devices (or related equipment) via the wearable computer devices. For example, exemplary systems and processes may use gesture driven head and hand-movements via an external gesture driven device to manipulate medical fluoroscopic equipment and cameras, for example, using gesture driven movements to turn fluoroscopy imaging on and off, to collimate an image, to move the operating table, to move the image detector in all 3-dimensional planes, and the like. A user may further manipulate (via gestures and/or voice commands) real-time feed data from medical laparoscopic, endoscopic, fluoroscopic cameras and image detectors—such as pausing, stopping, rewinding, fast-forwarding, and recording the data feed.

Work-Flow Entry Point Streamlining

One embodiment of the present invention comprises novel computer implemented methods and systems configured to facilitate a plurality of functions in a health care environment. In preferred embodiments, these methods and systems are operated by a processor running on a computer which may be a server or a mobile device such as a wearable computer.

As used herein, the term “computer” refers to a machine, apparatus, or device that is capable of accepting and performing logic operations from software code. The term “software”, “software code” or “computer software” refers to any set of instructions operable to cause a computer to perform an operation. Software code may be operated on by a “rules engine” or processor. Thus, the methods and systems of the present invention may be performed by a computer based on instructions received by computer software.

The term “client device” or sometimes “electronic device” or just “device” as used herein is a type of computer generally operated by a person. Non-limiting examples of client devices include: personal computers (PCs), workstations, laptops, tablet PCs including the iPad, cell phones with various operating systems (OS) including iOS phones made by Apple Inc., Android OS phones, Microsoft OS phones, BlackBerry phones, or generally any electronic device capable of running computer software and displaying information to a user. Certain types of client devices which are portable and easily carried by a person from one location to another may sometimes be referred to as “mobile devices.” Some non-limiting examples of mobile devices include: cell phones, smart phones, tablet computers, laptop computers, wearable computers such as watches, motion detecting bracelets or gloves, augmented reality glasses (e.g., Optical Head-Mounted Display (OHMD) devices such as Google Glass or the like), or other accessories incorporating any level of computing, and the like.

As used herein, the term “database” generally includes a digital collection of data or information stored on a data store such as a hard drive. Some aspects described herein use methods and processes to store, link, and modify information such as user profile information. A database may be stored on a remote server and accessed by a mobile device through a data network (e.g., WiFi) or alternatively in some embodiments the database may be stored on the mobile device or remote computer itself (i.e., local storage). A “data store” as used herein may contain or comprise a database (i.e., information and data from a database may be recorded into a medium on a data store).

In certain embodiments, the exemplary processes and systems described are in relation to medical information, medical records, health records, and the like. These data include, but are not limited to, medical imaging files, DICOM files, annotations, and patient specific reports. The processes and systems as described herein generally provide streamlined interaction with and manipulation of such medical data.

One advantage of the systems and processes described herein includes reducing friction. For example, friction includes the slight moment of hesitation by a user that often decides whether an action is started now, delayed, delayed forever, or if an all-together alternate course is taken. An exemplary system includes both “definitive” and “best-guess” entry mechanisms to identify an “entity” and trigger a work flow (e.g., a task to be completed by the user of wearable computer device). For example, a work-flow would be initiated with an entity or a list of potential entities from which a single entity can be selected.

An “entity” can be anything that is the subject of a work-flow. An entity may be a patient treatment area or the patient, but could also be a vial of blood, a container of stool, a tissue slide from a biopsy, or the like.

“Definitive” entry points include those that can identify an entity (room, patient, resource, or the like) with a high degree of confidence. Definitive entry points would be trusted enough that an entire work-flow could be started based on such an entry point; in such cases, the onus would be on the user to escape-out or cancel the work-flow if, for some reason, the work-flow was triggered for an incorrect entity. For example, definitive entry point mechanisms include (but are not limited to) the following:
Barcode (e.g., barcodes can be printed on items such as a traditional wrist-band, an ID card, an identification sticker on clothing, a medical file, a tube, a sample, or the like)
Quick Response (QR) Code
Iris scan
Fingerprint
Handprint/footprint
Inbound Communication ID (e.g., Caller ID)
Multi-factor mechanism—combinations of other definitive entry point mechanisms that add further certainty to an identification, or combinations including best-guess entry point mechanisms that bring the threshold of likelihood high enough to be treated as a definitive entry point mechanism.

Best-guess” entry points generally include mechanisms that can identify an entity with some degree of confidence or can at least reduce the population of potential entities to a small list from which selection can be made. It should be noted that as some of these technologies improve, they can eventually become “definitive” entry points and treated as such. It should also be noted that given the total population from which the entity is selected, and how many results are potentially returned, with few hits or one likely hit, a best-guess entry point can “cross-over” and be returned as a definitive entry point to reduce the friction of choice. For example, best-guess entry points include, but are not limited to, the following:
Optical character recognition of printed/displayed IDs
Voice recognition
Facial recognition
Location mapping
RF-ID signal (note that RF-ID is listed as “best-guess” instead of “definitive” since there may be more than a single RF-ID signal at a scan location from, for example, multiple patients)
Bluetooth including Bluetooth Low Energy 4.0 (BTLE 4.0)
Personal Device signature detection (e.g., smartphone WiFi MAC Address)

Which mechanisms are classified as definitive or best-guess as well as associated cross-over thresholds can be configurable by system users (e.g., a system administrator or the like). Further, system users could also define combinations of such mechanisms that, in union, can be treated as a definitive entry point mechanism.

Accordingly, in some examples, the particular dashboard, or information accessible via a user's computer wearable device may be triggered or filtered based on detected entry points. For example, vitals for a patient in a particular location could be displayed on the user's display, controls for medical devices at a particular location could be available, and so on. Further, depending on the particular detected entry points, a default means of communication may be selected for the user to communication with other users/physicians.

Central Repository

In one example, the system maintains a database for each entity with categorized party types and locations. For example, party types can include a surgeon, pathologist, radiologist, and so on. This database would be available to system clients to trigger work-flows accordingly. For example, if an emergency room physician is reviewing an X-ray, and wanted to initiate a phone call, the system would automatically know to search for the radiologist associated with this patient, for example, by looking up the proper files in a database. The central repository may also contain a mapping joining artifacts with party types and party-types with specific parties.

The central repository may also contain contact information, e.g., phone numbers, headset identifiers, video conference handles, or the like to facilitate seamless contact with other users.

Session Browsing and Exploration

The system may allow exploration and browsing of the context via multiple mechanisms to ensure the right mechanism is available at the right time. For example:
Traditional mouse/trackpad and keyboard control
Voice
Hand and arm Gestures
Body Gestures, especially head-gestures

The correct mechanism can be tailored for the particular setting, which can be an important feature. For example, a physician may be in a sterile environment unable to touch devices, so gesture and voice control would be preferred over traditional mouse or touch screen type control.

Alternatively, a physician may wish to interact with the system while their hands are soiled, with blood for example. Providing these alternative mechanisms eases the ability to have these interactions under such adverse conditions. The physician may even be able to multi-task (e.g., having a conversation or directing a program via voice controls while washing their hands).

The exemplary system may further include several native controls. Additionally, the system may be configurable by the user, administrator, and/or implementation engineers to enable specific actions based on specific triggering mechanisms.

Exemplary native controls may include one or more of the following:
Browsing stacks of images and videos with hand waves and other user-programmable gestures and voice commands;
Slow-panning and browsing stacks of images with head turns and based on the intensity and degree of head-turn;
Browsing stacks of images with voice commands (e.g., seeking previous, next, skip 10);
Playing, Pausing, Rewinding, Forwarding, and slowing videos with hand gestures;
Zooming into, zooming out of, showing annotations, hiding annotations and panning single images and paused videos with hand gestures;
Zooming into, zooming out of, showing annotations, hiding annotations and panning single images and paused videos with voice commands;
Exiting out of view mode with hand gestures, head gestures, or voice commands; and
Initiating contact with other physicians based on voice and gesture controls.

These sessions can be customized for the party type (e.g., type of physician) involved. In particular, the menus can be action-focused for surgeons, laparoscopic surgeons, and so on. For laparoscopic surgery, for example, the system would allow imaging to be browsed efficiently in the midst of surgery.

Synchronized Context

In one aspect, the system may allow two parties to browse and review the same image, set of images, video(s), records, or data synchronously. This may provide context for discussions and bring distance-communication closer to in-person communication. Each of the two or more parties can take turns being “presenter” and the presenter's exact context (e.g., location within a set of images, location within a video, mouse pointer, etc.) would be broadcast for the “attendee(s).” The attender's system would listen to the broadcast and ensure that both presenter and attender's systems are synchronized. The exemplary system's central audit-module can further listen to (or record) all broadcasts so broadcasts can be “replayed” exactly as they occurred. This can be useful for training and quality-measurement purposes.

Contextually-Triggered Communication

In one aspect, the exemplary process and system may initiate communication between appropriate parties, based on, for example, one or more of the work-flow in progress, the subject entity of the work-flow, the associated information for the entity in the aforementioned “centralized repository,” and on the desired means of communication. This communication could be a phone call, a video conference, text chat, or another available or desired communication method.

The desired method of communication may be automatically selected if only a single means of communication is possible. If multiple means are available, the system may allow the communication initiator to select one based on user input or a default mechanism. The system would allow the selection of a means of communication to be made by traditional mechanisms (e.g., keyboard, mouse, or trackpad) as well as alternative mechanisms (e.g., voice or gestures). As with most things on the system, the means to trigger communication can be driven by a set of natively supported events as well.

Equipment Control

The exemplary system and process may further allow users to control equipment via one or more wearable computer devices. For example, physicians and surgeons can directly control equipment via one or more wearable computer devices while maintaining a sterile field and/or prevent dirtying equipment controls/interfaces.

In one example, to prevent unintentional control of equipment, an opening sequence can be used to initiate control, e.g., an opening sequence could be either a voice command (e.g., “OK Control Equipment”), a gesture (e.g., two swoops of the arm), a traditional input (e.g., keyboard, mouse, GUI menu), or some user-programmed sequence combining all or some of these inputs. Similarly, a closing sequence can be used to allow users to end control of the equipment.

To control the devices, the exemplary system and process may allow individual commands (e.g., general commands such as “on” and “off”) or context-sensitive commands (e.g., such as “move the scope forward” or “rotate the scope on the axial plane”) to be mapped to a user-programmed sequence combining all or some of these inputs (e.g., voice, gesture, traditional inputs, or some combination of these). A central controller can listen to inputs (e.g., voice or gesture), and map the inputs to controls on the devices, either with native input interfaces on the equipment or via translators providing access to the equipment controls. The synergy of augmented reality, voice control, and gesture control allows for touch-free control, context-sensitive menus, and hierarchies of menus, making controls and actions easily available with minimal input. Further, users or organizations would be able to control the mapping of inputs and input combinations to particular machines, actions and contexts.

The exemplary processes and systems can be used with various types of medical equipment including, for example, the real-time control of fluoroscopy equipment and laparoscopic devices as these typically involve close patient contact as well as heavy equipment control.

Dashboards

According to another aspect, dashboards may be displayed on the wearable device with information from real-time sources and central repositories for a variety of EMR and EHR types, including but not limited to medical history, physical examination information, and allergies, lab result, lab result status, and the like. The information appearing can be summarized based on context and based on the type of physician viewing results and based on symptoms and diagnoses. For example, an emergency room physician can have dashboards prominently displaying medical tests ordered and which have been completed and are ready for viewing along with drug allergy information prominently displayed with vital signs streamed onto the display as well.

Displayed vital signs could be either real-time or historical or last-read, on augmented reality devices, either retrieved from a central repository or directly via connected devices (e.g., Bluetooth devices). The dashboards could be launched via traditional menus or via any entry-point mechanism as described earlier.

Auditing

According to another aspect, exemplary systems and process may be configured to audit each input across all input streams and audit each output presented to users, whether images or text or sound. This audit trail can be stored in a central repository to help with quality measurement and training. For instance, images, sound, displays, and actions can be stored for replay later in time in the same sequence etc., which can be used for review of procedures or instructional purposes.

Exemplary Processes

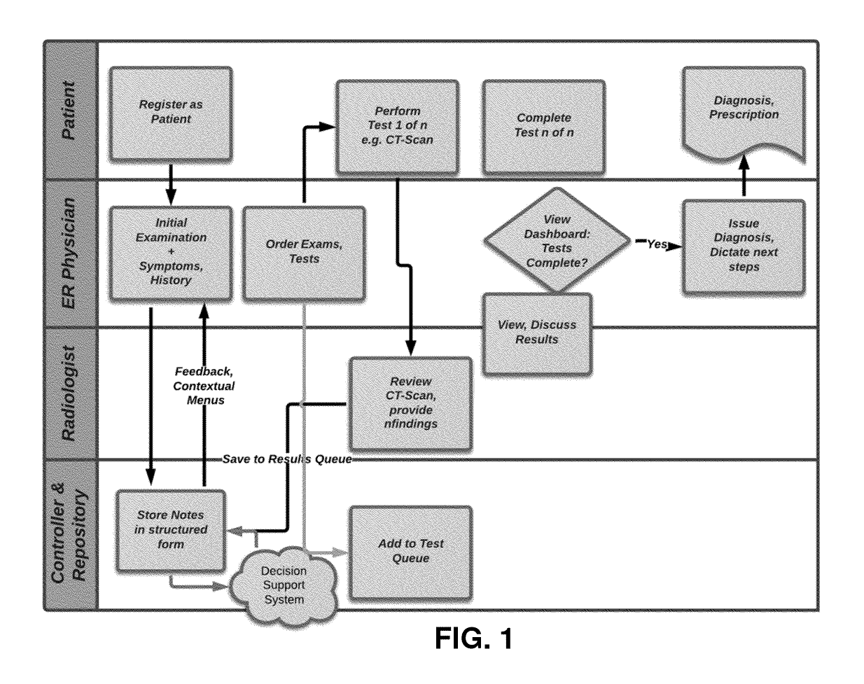

FIG. 1 illustrates an exemplary process flow associated with a patient visiting an emergency room, illustrating an emergency room physician interfacing with a radiologist and a clinical support decision system. For instance, as illustrated, a patient initially registers as such and receives an initial examination, e.g., by the emergency room (ER) physician (and/or nurse(s)). The initial ER physician may take notes regarding the patients issues, needs, symptoms, history, etc., and store them, e.g., in a repository.

The repository may include or be associated with a decision support system, which may trigger additional examinations, consultations, tests, and the like. For example, the ER physician may order, or the decision support system queues up, a medical test for the patient to undergo. In this example, a test (e.g., a CT-Scan) is then performed on the patient, and the results communicated to a radiologist for analysis. The radiologist then provides notes or comments to the repository for storage with the patient's records. Depending on the particular results, it may be advantageous for the ER physician and the radiologist to discuss the results, view the medical records together, and so on. Depending on their physical locations and workload, this coordination may prove difficult or time consuming. Once achieved, a diagnosis or health plan can be developed and issued to the patient in the form of a diagnosis, prescription, and the like.

As described herein, in one example, to alleviate the difficulty in coordinating between different hospital professionals, e.g., the ER physician and the radiologist, one or both of the professionals may initiate and communicate to the other with a wearable computing device. For instance, an ER physician may use a wearable computing device to access medical records and images associated with the CT-scan and further initiate communication with the radiologist to review the results in parallel. Further, if the radiologist also has a wearable computer device (or access to a computer) the two can review records in parallel while communicating (but without necessarily being physically together in a common location).

In some examples, communication between two users may be prompted by the repository, e.g., based on test results being available, the detected proximity of one or more of the users to other users or patients, and so on. Further, as described below, users may initiate interaction with the system or task flows based on input gestures or other triggers detectable by the wearable computer device. Further, users may initiate and control the use of medical equipment via wearable computer devices as described herein.

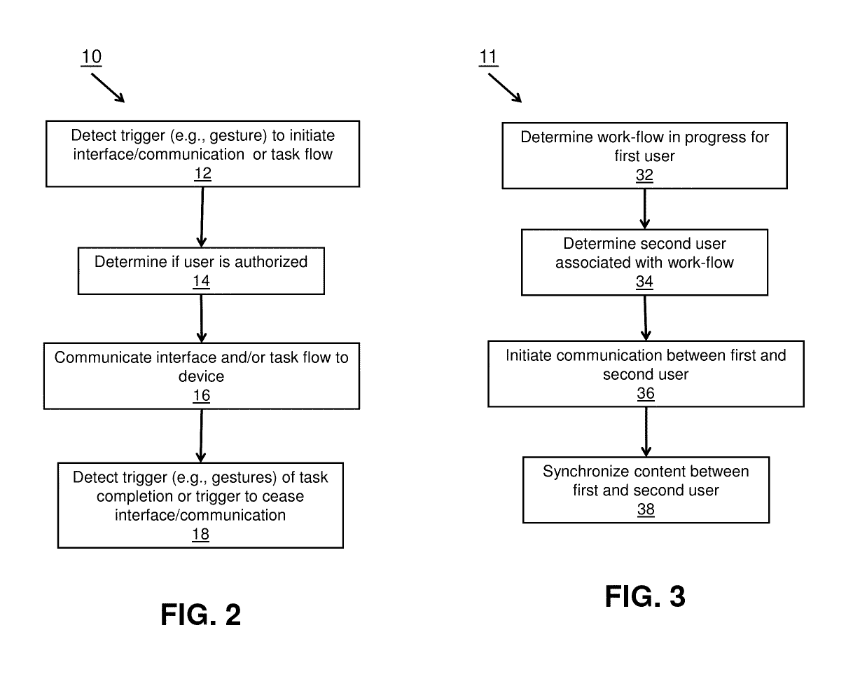

FIG. 2 illustrates an exemplary process 10 for initiating a medical interface or task flow (which may include viewing medical records, receiving information, controlling medical equipment, or the like). The process begins by detecting a trigger event at 12. The trigger event may include various trigger detectable by the wearable computer device, including, but not limited to, a hand gesture (detected by an image detector or via motion of the device itself), spoken command, selection of a button or input device associated with the wearable computer device, or combination thereof. The trigger event may further connect the wearable device to a medical application or module. The connection may include displaying a graphical user interface or open a connection for accepting commands from the user.

After, or in conjunction with, detecting the trigger, the process may determine if the user is authorized at 14 to communicate with the medical application, access records, control medical devise, and so on. This process may be performed initially and each time the user attempts to perform an action, e.g., each time the user attempts to access a medical record the authorization can be checked or confirmed.

Once triggered and authorized, a medical communication interface or process flow can then be communicated to the wearable computing device at 16. In one example, this may include providing a display for the user, e.g., a dashboard or medical records to view. This process may further include opening a communication channel with another user or health care professional, prompting the user for input, e.g., for notes or commands to be entered, opening a communication channel to a medical device to control, and so on.

In some examples, a dashboard can be displayed summarizing information based on the type of physician viewing results and based on symptoms and diagnoses. For example, an ER physician could have dashboards prominently displaying medical tests ordered and which have been completed and are ready for viewing along with drug allergy information prominently displayed. The dashboard can further be driven by a decision support system (e.g., such as the American College of Radiology (ACR) Appropriateness Criteria)

In some examples, the process may further include detecting a trigger indicating completion of a task or to cease the medical interface at 18. For example, a hand gesture, similar or different than the gesture to initiate the interface, may be used to disconnect or pause the connection to the medical interface (e.g., to end communication with another user, turn off a dashboard displaying medical records, end control of a medical device, and so on).

FIG. 3 illustrates an exemplary process 11 for initiating communication between two users (e.g., between two medical professionals), wherein at least one of the users is communicating via a wearable computer device. Similarly to process 10, the communication may be triggered by one or more hand gestures or voice commands. Additionally, in some examples, the process may determine a work-flow in progress by the first user at 32. For example, the process may determine that the user is reviewing a patient's files or performing a particular task. In response to determining a work-flow the process may determine a second user is associated with the work-flow at 34. For example, as an ER physician views medical records for a patient, the system may determine that a radiologist that recently completed a review of test results should be consulted.

The process may then initiate a communication with the second user at 36, where the communication can be initiated automatically or in response to a trigger from the first user. For example, the process may prompt the ER physician to initiate a communication with the radiologist. The communication may include a phone call, chat, email message. In one example, the communication may further include sharing a display between the ER physician and the radiologist, thereby allowing each to view the same records and/or images as they discuss the results in real time. Accordingly, in such an example, the process further synchronizes the display of content between the first and second user at 38. Further, similar to conventional presentation systems, control of the display can be handed back and forth as desired, and any number of users can join.

Exemplary Architecture and Operating Environment

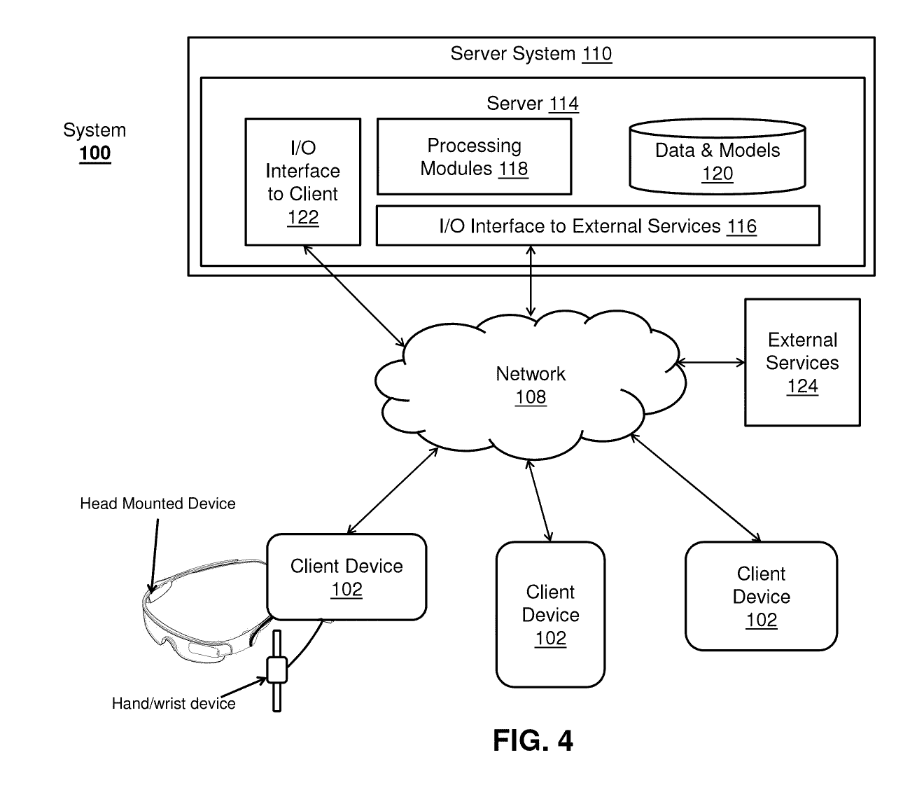

FIG. 4 illustrates an exemplary environment and system in which certain aspects and examples of the systems and processes described herein may operate. As shown in FIG. 4, in some examples, the system can be implemented according to a client-server model. The system can include a client-side portion executed on a user device 102 and a server-side portion executed on a server system 110. User device 102 can include any electronic device, such as a desktop computer, laptop computer, tablet computer, PDA, mobile phone (e.g., smartphone), wearable electronic device (e.g., digital glasses, wristband, wristwatch, gloves, etc.), or the like. In one example, a user device 102 includes wearable electronic device including at least an image detector or camera device for capturing images or video of hand gestures, and a display (e.g., for displaying notifications, a dashboard, and so on). For instance, user devices 102 may include augmented reality glasses, head mounted wearable devices (as illustrated), watches, and so on.

User devices 102 can communicate with server system 110 through one or more networks 108, which can include the Internet, an intranet, or any other wired or wireless public or private network. The client-side portion of the exemplary system on user device 102 can provide client-side functionalities, such as user-facing input and output processing and communications with server system 110. Server system 110 can provide server-side functionalities for any number of clients residing on a respective user device 102. Further, server system 110 can include one or more communication servers 114 that can include a client-facing I/O interface 122, one or more processing modules 118, data and model storage 120, and an I/O interface to external services 116. The client-facing I/O interface 122 can facilitate the client-facing input and output processing for communication servers 114. The one or more processing modules 118 can include various proximity processes, triggering and monitoring processes, and the like as described herein. In some examples, communication server 114 can communicate with external services 124, such as user profile databases, streaming media services, and the like, through network(s) 108 for task completion or information acquisition. The I/O interface to external services 116 can facilitate such communications.

Server system 110 can be implemented on one or more standalone data processing devices or a distributed network of computers. In some examples, server system 110 can employ various virtual devices and/or services of third-party service providers (e.g., third-party cloud service providers) to provide the underlying computing resources and/or infrastructure resources of server system 110.

Although the functionality of the communication server 114 is shown in FIG. 3 as including both a client-side portion and a server-side portion, in some examples, certain functions described herein (e.g., with respect to user interface features and graphical elements) can be implemented as a standalone application installed on a user device. In addition, the division of functionalities between the client and server portions of the system can vary in different examples. For instance, in some examples, the client executed on user device 102 can be a thin client that provides only user-facing input and output processing functions, and delegates all other functionalities of the system to a backend server.

It should be noted that server system 110 and clients 102 may further include any one of various types of computer devices, having, e.g., a processing unit, a memory (which may include logic or software for carrying out some or all of the functions described herein), and a communication interface, as well as other conventional computer components (e.g., input device, such as a keyboard/touch screen, and output device, such as display). Further, one or both of server system 110 and clients 102 generally includes logic (e.g., http web server logic) or is programmed to format data, accessed from local or remote databases or other sources of data and content. To this end, server system 110 may utilize various web data interface techniques such as Common Gateway Interface (CGI) protocol and associated applications (or “scripts”), Java® “servlets,” i.e., Java® applications running on server system 110, or the like to present information and receive input from clients 102. Server system 110, although described herein in the singular, may actually comprise plural computers, devices, databases, associated backend devices, and the like, communicating (wired and/or wireless) and cooperating to perform some or all of the functions described herein. Server system 110 may further include or communicate with account servers (e.g., email servers), mobile servers, media servers, and the like.

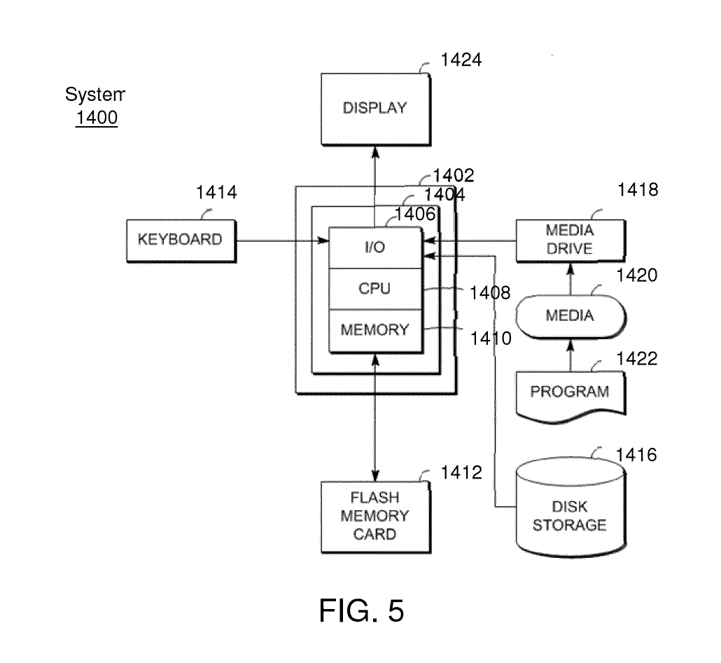

It should further be noted that although the exemplary methods and systems described herein describe use of a separate server and database systems for performing various functions, other embodiments could be implemented by storing the software or programming that operates to cause the described functions on a single device or any combination of multiple devices as a matter of design choice so long as the functionality described is performed. Similarly, the database system described can be implemented as a single database, a distributed database, a collection of distributed databases, a database with redundant online or offline backups or other redundancies, or the like, and can include a distributed database or storage network and associated processing intelligence. Although not depicted in the figures, server system 110 (and other servers and services described herein) generally include such art recognized components as are ordinarily found in server systems, including but not limited to processors, RAM, ROM, clocks, hardware drivers, associated storage, and the like (see, e.g., FIG. 5, discussed below). Further, the described functions and logic may be included in software, hardware, firmware, or combination thereof.

FIG. 5 depicts an exemplary computing system 1400 configured to perform any one of the above-described processes, including the various notification and compliance detection processes described above. In this context, computing system 1400 may include, for example, a processor, memory, storage, and input/output devices (e.g., monitor, keyboard, disk drive, Internet connection, etc.). However, computing system 1400 may include circuitry or other specialized hardware for carrying out some or all aspects of the processes. In some operational settings, computing system 1400 may be configured as a system that includes one or more units, each of which is configured to carry out some aspects of the processes either in software, hardware, or some combination thereof.

FIG. 5 depicts computing system 1400 with a number of components that may be used to perform the above-described processes. The main system 1402 includes a motherboard 1404 having an input/output (“I/O”) section 1406, one or more central processing units (“CPU”) 1408, and a memory section 1410, which may have a flash memory card 1412 related to it. The I/O section 1406 is connected to a display 1424, a keyboard 1414, a disk storage unit 1416, and a media drive unit 1418. The media drive unit 1418 can read/write a computer-readable medium 1420, which can contain programs 1422 and/or data.

At least some values based on the results of the above-described processes can be saved for subsequent use. Additionally, a non-transitory computer-readable medium can be used to store (e.g., tangibly embody) one or more computer programs for performing any one of the above-described processes by means of a computer. The computer program may be written, for example, in a general-purpose programming language (e.g., Pascal, C, C++, Java) or some specialized application-specific language.

Various exemplary embodiments are described herein. Reference is made to these examples in a non-limiting sense. They are provided to illustrate more broadly applicable aspects of the disclosed technology. Various changes may be made and equivalents may be substituted without departing from the true spirit and scope of the various embodiments. In addition, many modifications may be made to adapt a particular situation, material, composition of matter, process, process act(s) or step(s) to the objective(s), spirit or scope of the various embodiments. Further, as will be appreciated by those with skill in the art, each of the individual variations described and illustrated herein has discrete components and features that may be readily separated from or combined with the features of any of the other several embodiments without departing from the scope or spirit of the various embodiments. All such modifications are intended to be within the scope of claims associated with this disclosure.

What is claimed:

1. A computer-implemented method for communicating in a health care environment, the method comprising:
at an electronic device having at least one processor and memory:
receiving a trigger from a wearable computer device to communicate with a medical application interface, wherein the trigger comprises a gesture;
causing a display associated with the medical application interface on the wearable computer device; and
receiving input from a user via the wearable computer device for interacting with the medical application interface.

2. The method of claim 1, wherein the medical application interface is for providing communication between a user of the wearable computer device and at least one other user.

3. The method of claim 2, wherein the at least one other user communicates through a second wearable computer device.

4. The method of claim 2, further comprising causing synchronization of displayed content between the wearable computer device of the first user and the at least one other user.

5. The method of claim 1, wherein the medical application interface is for providing access to medical information.

6. The method of claim 1, wherein the medical application interface is for controlling medical equipment.

7. The method of claim 1, further comprising detecting a gesture for manipulating medical equipment, and communicating a signal to the medical equipment for control thereof.

8. The method of claim 1, further comprising causing communication of images captured from a medical device for display with the wearable computer device.

9. The method of claim 8, wherein the medical device comprises one or more of a laparoscopic, endoscopic, or fluoroscopic camera device.

10. The method of claim 1, further comprising receiving a second trigger to cease communication with the medical application interface.

11. The method of claim 1, further comprising receiving a second trigger to pause communication with the medical application interface.

12. The method of claim 1, wherein the trigger comprises a gesture captured by an image detector of the wearable computer device.

13. The method of claim 1, wherein the trigger comprises a voice command.

14. The method of claim 1, further comprising causing communication of medical images to the wearable computer device for display therewith.

15. The method of claim 1, further comprising causing communication of medical vitals of a patient to the wearable computer device for display therewith.

16. A non-transitory computer-readable storage medium comprising computer-executable instructions for:
receiving a trigger from a wearable computer device to communicate with a medical application interface, wherein the trigger comprises a gesture;
causing a display associated with the medical application interface on the wearable computer device; and
receiving input from a user via the wearable computer device for interacting with the medical application interface.

17. The non-transitory computer-readable storage medium of claim 16, wherein the medical application interface is for providing communication between a user of the wearable computer device and at least one other user.

18. The non-transitory computer-readable storage medium of claim 16, further comprising instructions for causing synchronization of displayed content between the wearable computer device of the first user and the at least one other user.

19. A system comprising:
one or more processors;
memory; and
one or more programs, wherein the one or more programs are stored in the memory and configured to be executed by the one or more processors, the one or more programs including instructions for:
receiving a trigger from a wearable computer device to communicate with a medical application interface, wherein the trigger comprises a gesture;
causing a display associated with the medical application interface on the wearable computer device; and
receiving input from a user via the wearable computer device for interacting with the medical application interface.

20. The system of claim 19, wherein the medical application interface is for providing communication between a user of the wearable computer device and at least one other user.

21. The system of claim 19, further comprising instructions for causing synchronization of displayed content between the wearable computer device of the first user and the at least one other user.
